(19) United States
(12) Patent Application Publication
(10) Pub. No.: US 2026/0021980 A1
(43) Pub. Date: Jan. 22, 2026

(54) STATUS DETECTION APPARATUS FOR CENTRAL TELESCOPIC FEEDING PIPE IN COAL STORAGE EUROSILO

(71) Applicant: HUANENG POWER INTERNATIONAL, INC. SHANGHAI SHIDONGKOU FIRST POWER PLANT, Shanghai (CN)

(72) Inventors: Xiao Zhang, Shanghai (CN); Haokai Chen, Shanghai (CN); Sijia Lu, Shanghai (CN); Ning Zhang, Shanghai (CN)

(73) Assignee: HUANENG POWER INTERNATIONAL, INC. SHANGHAI SHIDONGKOU FIRST POWER PLANT, Shanghai (CN)

(21) Appl. No.: 19/251,788

(22) Filed: Jun. 26, 2025

(30) Foreign Application Priority Data
Jul. 22, 2024 (CN) 202410980980.X

(51) Int. Cl. B65G 65/38

(52) U.S. Cl. CPC B65G 65/38; B65G 2203/0283; B65G 2203/047

(57) ABSTRACT

A status detection apparatus for a central telescopic feeding pipe is installed between an Eurosilo feeding inlet and a connecting section and includes an upper connection fixing body, a lower connection sliding body, a spring, and a detector. The upper connection fixing body is connected to a lower end of the Eurosilo feeding inlet, and the lower connection sliding body is connected to an upper end of the connecting section, the upper connection fixing body and the lower connection sliding body are connected via the spring, the connecting section is inserted into a first section of round pipes of a central telescopic feeding pipe and is dragged to be connected to an upper limit stop ring of the first section, and the detector detects a relative displacement between the upper connection fixing body and the lower connection sliding body to determine a telescopic status of the central telescopic feeding pipe.

### CROSS-REFERENCE TO RELATED APPLICATION

This application claims the priority benefit of China application serial no. 202410980980.X, filed on Jul. 22, 2024. The entirety of the above-mentioned patent application is hereby incorporated by reference herein and made a part of this specification.

### BACKGROUND

### Technical Field

The present invention relates to the technical field of device detection for thermal power plants, and particularly relates to a status detection apparatus for a central telescopic feeding pipe in a coal storage Eurosilo.

### Description of Related Art

Eurosilo coal storage is a latest environmentally friendly method for coal storage. Currently, domestic thermal power enterprises have introduced an Eurosilo technology for the coal storage. However, some issues have arisen during the use of the Eurosilo coal storage, which directly affect a safe and stable operation of an Eurosilo.

As shown in FIG. 1, numerous devices are arranged inside the Eurosilo. These devices are primarily used for stacking and storing coal from low to high levels within the Eurosilo, extracting coal in the Eurosilo from high to low levels, and outputting coal from the Eurosilo. The Eurosilo mainly consists of components such as an Eurosilo cylindrical silo wall 1, an Eurosilo feeding inlet 2, an Eurosilo top trestle 3, a rotary trestle 4, a rotary trestle traveling apparatus 5, a central telescopic feeding pipe 6, a spiral frame lifting wire rope 7, a spiral frame 8, a screw conveyor 9, a dust cover for guide chute 10, a spiral frame type-A frame 11, a central winch platform 12, a central rotary platform 13, and a spiral frame central platform 14.

As shown in FIG. 2 to FIG. 4, the central telescopic feeding pipe 6 of the Eurosilo is composed of several sections of round pipes with different diameters nested and hooked together. Each section has a fixed length, and the number of the sections of the round pipes and a length of each section of the round pipes are determined according to a total telescopic length range. The central telescopic feeding pipe consists of several sections of round pipes of an equal length, an identical structure, and varying diameters, vertically installed along a central axis of the Eurosilo. From one end of the central telescopic feeding pipe to the other, i.e., from top to bottom, a diameter of each section of the round pipes increases sequentially. Adjacent round pipes may nest and slide into each other. This feature enables the central telescopic feeding pipe to extend and retract. The central telescopic feeding pipe 6 serves as a coal conveying channel for coal entering the Eurosilo through a feed inlet at the top of the Eurosilo and accumulating inside. When the Eurosilo is empty, i.e., in an empty Eurosilo status, all round pipes of the central telescopic feeding pipe 6 are fully extended without overlapping. As coal enters the Eurosilo and accumulates, a height of a coal pile increases, causing the central telescopic feeding pipe 6 to gradually shorten. Lower round pipes of the central telescopic feeding pipe 6 begin to retract and overlap until the coal pile reaches its maximum height. At this point, a spiral frame 8 and a screw conveyor 9 ascend to their highest positions, and the central telescopic feeding pipe 6 retracts to a certain length, with most of the round pipes overlapping and nesting together.

A typical Eurosilo consists of 12 sections of round pipes. Each section of the round pipe comprises an upper limit stop ring 6-2-1, a round pipe body 6-2-2, and a lower limit stop block 6-2-3. When two adjacent nested sections extend, an upper surface of the lower limit stop block 6-2-3 on a smaller-diameter round pipe hooks onto a lower surface of the upper limit stop ring 6-2-1 on a larger-diameter round pipe, thereby enabling synchronized movement after hooking. When the two adjacent nested sections retract, the sections can nest and overlap. An upper end of the central telescopic feeding pipe 6 is connected to a bottom of the feeding inlet at the top of the Eurosilo through a flange interface, while a lower end of the central telescopic feeding pipe 6 is connected to the guide chute 10 on the spiral frame central platform 14.

When the coal is loaded into the Eurosilo for stacking, it enters through the upper end of the central telescopic feeding pipe 6 and flows along the central telescopic feeding pipe 6 onto the coal pile inside the Eurosilo. The upper end of the central telescopic feeding pipe 6 is connected to the coal feeding outlet of the conveyor located at the center top of the Eurosilo, while the lower end of the central telescopic feeding pipe 6 is connected to a material receiving point on the spiral frame 8. Thus, the central telescopic feeding pipe 6 serves as a mandatory passage for coal entering the Eurosilo. During coal stacking, the length of the central telescopic feeding pipe 6 shortens as the spiral frame 8 ascends. During coal extraction, the length of the central telescopic feeding pipe 6 extends as the spiral frame 8 descends. The central telescopic feeding pipe 6 has a telescopic function, which can avoid scattering of coal during a falling process when entering the Eurosilo, and ensure that the falling coal always lands on the material receiving point of the spiral frame 8 to prevent the coal from directly impacting the coal pile. At the same time, it reduces coal dust, ensuring the orderly and safe stacking of coal in the Eurosilo.

Since the central telescopic feeding pipe 6 is composed of several concentric sections of round pipes with different diameters, each section of the round pipes having the same length. From the top down, the diameters of the round pipes increase sequentially from the first section to the last. This design allows each upper section to be inserted into the adjacent lower section, and this insertion is repeated sequentially so that all round pipes can eventually be inserted into the last one, forming a so-called transport status. Each section of the round pipes is equipped with stepped sections of different diameters at both ends as sliding limit connectors, which allow adjacent sections to slide against each other while remaining hooked and connected without separation, and also enable relative sliding along the central axis of the round pipe body. This structure enables several sections of the feeding pipes to be connected along a central axis, unfolding or contracting section by section as a distance between the two ends extends or retracts. This structural feature allows a distance between the feeding inlet and a discharging outlet of the central telescopic feeding pipe to change with a distance between the rotary trestle 4 and the spiral frame 8, ensuring that materials always pass through the central telescopic feeding pipe 6. When the spiral frame 8 is at its highest position, the central telescopic feeding pipe 6 is retracted to its shortest length. Since the central telescopic feeding pipe 6 is in a vertical status, each section of the round pipes is stacked on the lower one under action of gravity. When the spiral frame 8 descends, starting from a topmost first section, each section is sequentially pulled out one by one until a penultimate section is fully pulled out. At this point, the spiral frame 8 has reached a lowest part of the Eurosilo, and all coal in the Eurosilo has been emptied. When coal is fed into the Eurosilo for stacking, the spiral frame 8 gradually ascends, and the fully extended central telescopic feeding pipe 6 begins to retract. During retraction, the penultimate section (from the bottom) is inserted into the last section. When fully inserted, the penultimate section remains in a stationary status relative to the last section. As the spiral frame 8 continues to ascend, the third-to-last section starts to insert into the penultimate section. In this way, as the spiral frame 8 ascends higher, the central telescopic feeding pipe 6 retracts into a lower section of round pipe. When the spiral frame 8 reaches the highest point, the entire central telescopic feeding pipe 6 is contracted into the lowermost round pipe. The extension and retraction of the central telescopic feeding pipe 6 always remain consistent with upward and downward movements of the spiral frame 8.

In current practical applications, lignite is the main coal used for power generation in China. It has a high proportion of powdery particles, high volatile matter and moisture content, and strong viscosity. This type of coal is relatively inexpensive, which can effectively reduce power generation costs and improve economic benefits. Therefore, using this kind of coal has become a trend in the power generation industry. However, when storing such coal in the Eurosilo, phenomena such as coal dust mixed with water vapor adhering to a wall of the central telescopic feeding pipe 6 are prone to occur. The adhered coal would hinder the extension or retraction of the central telescopic feeding pipe 6, affect the normal sliding of each section of round pipes, and may even bond a plurality of sections of the feeding pipe into a whole. When the spiral frame 8 continues to ascend or descend, if the central telescopic feeding pipe 6 cannot extend or retract synchronously due to adhesion, it would cause damage to the central telescopic feeding pipe 6, leading to a failure of an Eurosilo device to operate. Additionally, the environment inside the Eurosilo is relatively unique, with various combustible gases and coal present. Maintenance of the central telescopic feeding pipe 6 is extremely challenging. Once damaged, repairs require significant manpower and resources, as well as substantial downtime for the Eurosilo, severely impacting normal coal loading and unloading operations of the Eurosilo storage device.

Due to the nested structure of the central telescopic feeding pipe 6, existing feeding pipes cannot be equipped with status detection sensors for the feeding pipe to monitor the telescopic movement of each nested section of round pipe. The current Eurosilo central telescopic feeding pipe cannot be fitted with a corresponding detection apparatus to prevent damage caused by jamming. In actual Eurosilo operations, both domestic and international Eurosilos have experienced damage failures caused by the jamming of the central telescopic feeding pipe, severely affecting operational stability of coal storage of the Eurosilo.

### SUMMARY

The objective of the present invention is to overcome the defects in the prior art and provide a status detection apparatus for a central telescopic feeding pipe in a coal storage Eurosilo. This apparatus can accurately and in real-time detect a telescopic status of the central telescopic feeding pipe without affecting a nested structure of the central telescopic feeding pipe, ensuring operational stability of coal storage of the Eurosilo.

The objective of the present invention can be achieved through the following technical solution: a status detection apparatus for a central telescopic feeding pipe in a coal storage Eurosilo, which is installed between an Eurosilo feeding inlet and a connecting section and comprises an upper connection fixing body, a lower connection sliding body, a spring body, and a detector, wherein the upper connection fixing body is connected to a flange at a lower end of the Eurosilo feeding inlet, and the lower connection sliding body is connected to a flange at an upper end of the connecting section, the upper connection fixing body and the lower connection sliding body are connected via the spring body, the connecting section is inserted into a first section of round pipes of a central telescopic feeding pipe and is dragged to be connected to an upper limit stop ring of the first section of round pipes, and the detector is configured to detect a relative displacement between the upper connection fixing body and the lower connection sliding body to determine a current corresponding telescopic status of the central telescopic feeding pipe.

Further, an internal sealing belt is arranged between the upper connection fixing body and the lower connection sliding body, an external sealing sleeve is fixedly connected to outer sides of the upper connection fixing body and the lower connection sliding body via a hoop sleeve, and the internal sealing belt and the external sealing sleeve are configured to enclose the spring body in a space unaffected by an internal environment of the Eurosilo, ensuring that a relative movement between the upper connection fixing body and the lower connection sliding body is performed in a stable environment.

Further, the upper connection fixing body comprises a connecting ring, an upper connecting flange, a straight section of the feeding pipe, an inclined section of the feeding pipe, and a connecting ring base plate, wherein the upper connecting flange is connected to the flange at the lower end of the Eurosilo feeding inlet via a bolt; the connecting ring base plate is configured to support and connect the spring body; the inclined section of the feeding pipe is connected to a lower end of the straight section of the feeding pipe, jointly serving as a coal passage; and the inclined section of the feeding pipe is configured to prevent coal from impacting the internal sealing belt.

Further, an inspection hole is provided on a wall surface of the connecting ring, and a spring guide rod guiding hole is provided on the connecting ring base plate.

Further, the lower connection sliding body comprises an upper bearing surface and a lower connecting flange, wherein a feeding pipe is connected between the upper bearing surface and the lower connecting flange, the upper bearing surface is configured to be fixedly connected to spring body, the lower connecting flange is connected to the connecting section, and the feeding pipe serves as the coal passage.

Further, a lower part of the lower connection sliding body is further provided with a sealing member fixing ring, which is configured to press and fix a port of the external sealing sleeve via the hoop sleeve.

Further, the spring body comprises an upper seat plate and a lower seat plate, with a plurality of springs connected between the upper seat plate and the lower seat plate; the upper seat plate is fixedly connected to the upper bearing surface of the lower connection sliding body; a guiding screw is arranged on the upper seat plate, and a large-diameter cylindrical platform is arranged between the guiding screw and the upper seat plate for spring positioning and guiding; and a spring guiding body for the spring positioning and guiding is provided on the lower seat plate.

Further, the detector comprises an upper fixed frame and a lower movable frame arranged in the same vertical plane; the upper fixed frame is fixed on an upper surface of the connecting ring of the upper connection fixing body; the lower movable frame is fixed on a lower plane of the sealing member fixing ring; a rotating shaft is provided on the upper fixed frame; an action arm is installed on the rotating shaft; the action arm has a lever feature, with several sensing holes as sensing bodies provided at one end of the action arm; a sensor is installed on the upper fixed frame, with sensing points of the sensor aligned with the sensing bodies; the sensor is connected to an Eurosilo control system; and when the sensor approaches these sensing bodies, the sensor triggers an electrical signal, which is transmitted to the Eurosilo control system to reflect a current telescopic status of the central telescopic feeding pipe.

Further, a connecting pin of the action arm is connected to the lower movable frame via a connecting rod, converting the relative displacement between the upper connection fixing body and the lower connection sliding body into a rotation angle of the action arm, and allowing the sensor to sense actions of the sensing bodies.

Further, the sensor is specifically a non-contact proximity limit sensor.

Compared with the prior art, the present invention has the following advantages:

In the present invention, the detection apparatus is installed between the Eurosilo feeding inlet and the connecting section. In this detection apparatus, the upper connection fixing body and the lower connection sliding body are connected by the spring body, which is characterized by being able to change its spacing under an external force; the upper connection fixing body is fixedly connected to the Eurosilo feeding inlet, while the lower connection sliding body is connected to the connecting section 25; and the connecting section is inserted into the central telescopic feeding pipe, and it drags the uppermost section, namely the first section of the round pipes, of the central telescopic feeding pipe. When the central telescopic feeding pipe extends or retracts, the weight of the extended part of the round pipes is transmitted upward to the Eurosilo feeding inlet; after adding the detection apparatus, this weight acts on the spring body via the lower connection sliding body, causing the spring body to compress and the axial distance between the upper connection fixing body and the lower connection sliding body to be shorten; the extension length of the central telescopic feeding pipe is directly proportional to the compression amount of the spring body, that is, proportional to the axial spacing between the upper connection fixing body and the lower connection sliding body; by using the detector arranged on the detection apparatus, the change of the axial spacing between the upper connection fixing body and the lower connection sliding body can be reflected in real-time, so as to detect the current corresponding telescopic status of the central telescopic feeding pipe. The present invention does not require altering the original device structure of the Eurosilo; by fully utilizing and matching the structural characteristics of the device inside the Eurosilo, it enables monitoring of the telescoping actions of the central telescopic feeding pipe, promptly identifying abnormal conditions, avoiding various damages caused by jamming, and effectively improving the operational stability and reliability of the central telescopic feeding pipe.

In the present invention, the internal sealing belt is arranged between the upper connection fixing body and the lower connection sliding body, and the external sealing sleeve is fixedly connected to the outer sides of the upper connection fixing body and the lower connection sliding body via the hoop sleeve; the internal sealing belt connects the coal feeding pipeline between the upper connection fixing body and the lower connection sliding body, preventing coal dust from escaping through the seams; through the internal sealing belt and the external sealing sleeve, all components of the spring body are enclosed in the space unaffected by the internal environment of the Eurosilo; the relative movement between the upper connection fixing body and the lower connection sliding body also occurs entirely within the closed and stable environment, ensuring the operational reliability of the detection apparatus.

In the present invention, a tubular straight section of the feeding pipe and its connected inclined section of the feeding pipe are designed within the upper connection fixing body; the inclined section of the feeding pipe has a conical feature, with a smaller diameter than the straight section, thereby preventing coal from impacting the internal sealing belt during its descent; and additionally, a certain number of maintenance holes are provided on the external cylindrical surface of the upper connection fixing body, further facilitating future maintenance and inspection needs.

In the present invention, the rotating shaft is provided on the upper fixed frame of the detector, and the action arm is installed on the rotating shaft; the action arm has the lever feature, with several sensing holes as sensing bodies at one end; the sensor is installed on the upper fixed frame, with the sensing points of the sensor aligned with the sensing bodies; and when the sensor approaches these sensing bodies, it triggers the electrical signal, which is transmitted to the Eurosilo control system, wherein the action arm rotates around the rotating shaft within a certain angle range, with unequal distances from both ends of the action arm to the rotating shaft; if the distance from the sensing bodies to the rotating shaft is designed to be several times the distance from the connecting pin to the rotating shaft, the movement distance of the sensing bodies is several times the actual relative displacement between the upper connection fixing body and the lower connection sliding body. This enables more precise detection feedback. The connecting pin of the action arm is connected to the lower movable frame via the connecting rod, converting the relative displacement between the upper connection fixing body and the lower connection sliding body into the rotation angle of the action arm, allowing the sensor to detect the movement of the sensing bodies in a timely and accurate manner.

### BRIEF DESCRIPTION OF THE DRAWINGS

FIG. 1 is a schematic diagram of an overall structure of an Eurosilo;

FIG. 2 is a schematic diagram of a sectional structure of a central telescopic feeding pipe;

FIG. 3 is a schematic diagram of a single section of a round pipe;

FIG. 4 is a schematic diagram of a sectional structure of a connection between round pipes;

FIG. 5 is a schematic diagram of an installation effect of the present invention;

FIG. 6 is a schematic diagram of a connection between an existing Eurosilo feeding inlet and a connecting section;

FIG. 7 is a structural schematic diagram of the connecting section;

FIG. 8 is a structural schematic diagram of the present invention;

FIG. 9 is a structural schematic diagram of an upper connection fixing body in the present invention;

FIG. 10 is a structural schematic diagram of a lower connection sliding body in the present invention;

FIG. 11 is a structural schematic diagram of a spring body in the present invention;

FIG. 12 is a schematic diagram of an upper spring seat in the present invention;

FIG. 13 is a schematic diagram of a lower spring seat in the present invention; and

FIG. 14 is a structural schematic diagram of a detector in the present invention.

### DESCRIPTION OF THE EMBODIMENTS

The present invention will be elaborated hereafter in conjunction with the accompanying drawings and specific embodiments.

### Embodiments

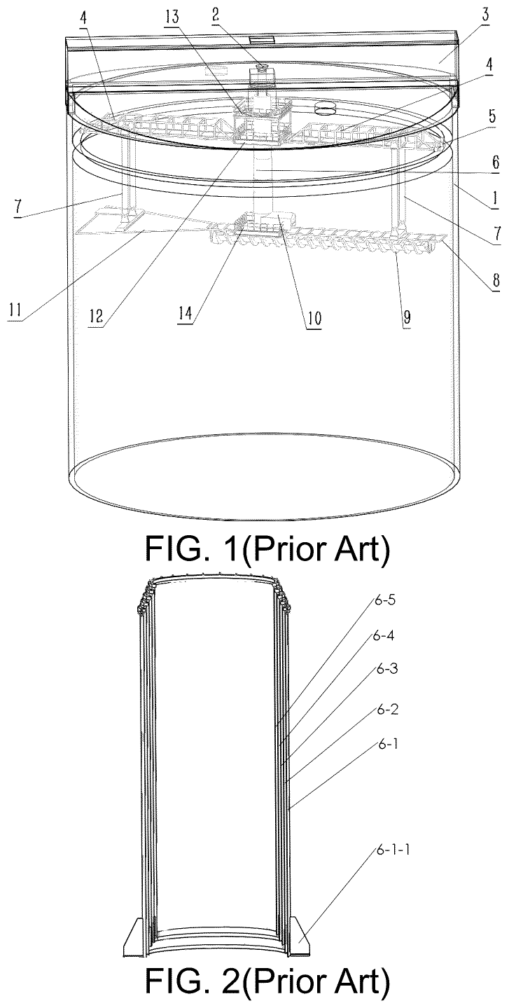

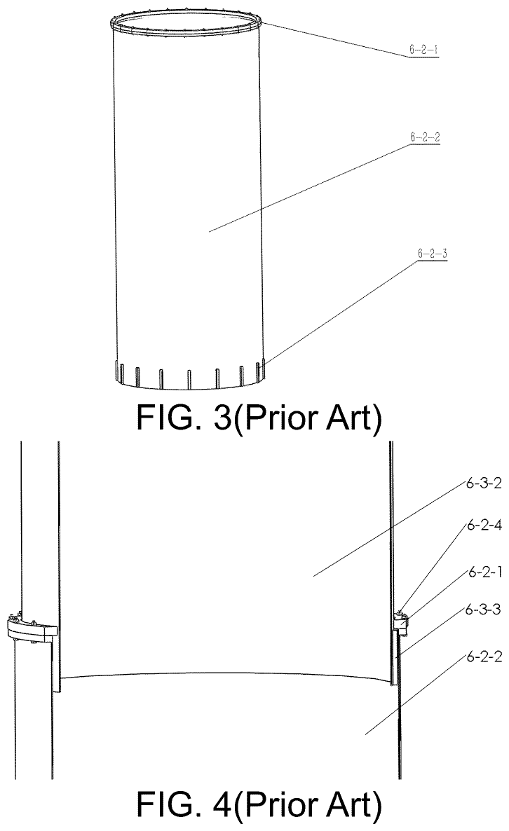

To facilitate understanding of this scheme, an existing coal storage structure and operating principle of the Eurosilo are described as follows: as shown in FIG. 1 to FIG. 4, when a spiral frame of the Eurosilo ascends or descends according to operational requirements, a central telescopic feeding pipe 6 needs to extend or retract, ensuring that there is always a feeding pipe connection between a central winch platform 12 and a spiral frame central platform 14 of the Eurosilo. This ensures that coal entering the Eurosilo continuously falls through the feeding pipe. The extension and retraction of the central telescopic feeding pipe 6 are achieved through interconnection of several sections of round pipes with different diameters, which can slide relative to each other. These interconnected round pipes have diameters that increase sequentially from top to bottom, with the diameters of the upper round pipes being smaller than that of the lower one. A diameter difference between two adjacent round pipes ensures that a smaller-diameter round pipe may be inserted into an adjacent larger-diameter round pipe. Since each section of the round pipes in the central telescopic feeding pipe 6 may be inserted into the adjacent larger-diameter round pipe, this feature ensures that an uppermost round pipe of the central telescopic feeding pipe 6 has a smallest diameter, while a lowermost round pipe has a largest diameter, enabling the entire central telescopic feeding pipe 6 to perform extension and retraction movements. Meanwhile, an upper limit stop ring 6-2-1 and a lower limit stop block 6-2-3 are provided on each section of round pipes. The upper end of the smallest-diameter section of round pipes of the central telescopic feeding pipe 6 is connected to a feeding inlet on a central rotating platform 13 of the Eurosilo, while a lower end of the largest-diameter section of round pipes (that is, the first section of round pipes 6-1) of the central telescopic feeding pipe 6 is fixedly connected to a spiral frame central platform 14. It is fixedly connected to the spiral frame central platform 14 through a foundation of first section of round pipes 6-1-1, with the center of the round pipe aligned with a coal falling hole provided at a center of the spiral frame central platform 14. The central telescopic feeding pipe is always kept in a vertical status.

Taking the second section of round pipes 6-2 as an example, the upper limit stop ring 6-2-1 and the lower limit stop block 6-2-3 are introduced. When a third section of round pipes 6-3 extends out of the second section of round pipes 6-2, and when the third section of round pipes extends to its maximum distance, the lower limit stop block 6-3-3 of the third section of round pipes 6-3 is blocked by the upper limit stop ring 6-2-1 of the second section of round pipes 6-2, causing the third section of round pipes 6-3 to drag the second section of round pipes 6-2 upward. By analogy, as the spiral frame central platform 14 continues to descend, the central telescopic feeding pipe extends. Between two adjacent sections of round pipes, an upper section of round pipes drives an upper limit stop block of a lower section of round pipes upward via a lower limit stop block, achieving an extended status. As the central telescopic feeding pipe continues to extend, each upper section of round pipes drives a lower one to unfold sequentially until all round pipes are fully extended. When the spiral frame central platform 14 continuously ascends, the central telescopic feeding pipe 6 needs to retract continuously. From bottom to top, for two adjacent sections of round pipes, a smaller-diameter round pipe is gradually inserted into a larger-diameter one until an upper limit stop ring of the smaller-diameter round pipe touches an upper limit stop ring of the next section. Then a next upper section of round pipes starts to be inserted into this section. Through such sequential insertion and nesting of adjacent round pipes, the upper limit stop rings stack up subsequently, enabling the central telescopic feeding pipe 6 to achieve a retracted status.

The extension and retraction of the central telescopic feeding pipe 6 are achieved through the relative movement between the round pipes. Under influence of gravity, in a normal circumstance, whether the central telescopic feeding pipe extends or retracts, a relative displacement between the round pipes always occurs between the first section and the second section from bottom to top. The extended round pipe always begins with a smallest-diameter section, while the other round pipes move downward sequentially. As the spiral frame central platform 14 continues to descend, the smaller-diameter round pipe drags the adjacent larger-diameter round pipe to extend section by section, until a largest extendable section of round pipes is fully extended from the first section of round pipes 6-1. When the spiral frame central platform 14 ascends, the central telescopic feeding pipe starts to retract. During retraction, the largest-diameter extendable section of round pipes first inserts into the first section of round pipes 6-1, followed by sequential insertion from a larger-diameter section of round pipes until the smallest-diameter section of round pipes is fully retracted. After a section of round pipes is fully extended from an adjacent one, if the central telescopic feeding pipe continues to extend, this section of round pipes would remain in a stationary status relative to the adjacent section of round pipes and sections of round pipes that drag it. Conversely, when the central telescopic feeding pipe retracts, once a section of round pipes is fully inserted into an adjacent one, it would stay in a stationary status.

The existing central telescopic feeding pipe of the Eurosilo consists of 13 sections. Except for the first section, the remaining 12 sections may achieve an extended or retracted status. For simplification in this embodiment, only five sections of round pipes are illustrated schematically.

The following is an analysis of the movements of the round pipes:

When the spiral frame central platform 14 descends and the central telescopic feeding pipe 6 extends to a certain distance, during extension of a fourth section of round pipes, the fourth section of round pipes 6-4 cannot continue to descend along with the spiral frame central platform 14 due to a dragging force of the lower limit stop block of the fifth section of round pipes 6-5. As a result, under the influence of gravity, the third section of round pipes 6-3 continues to descend, causing the fourth section of round pipes to extend out of the third section of round pipes 6-3, the second section of round pipes 6-2, and the first section of round pipes 6-1:
a. the third section of round pipes and the second section of round pipes, along with the first section of round pipes begin to move downward with the spiral frame central platform 14, causing the fourth section of round pipes 6-4 to extend;
b. during the extension of the fourth section of round pipes 6-4, no other round pipes (the third section of round pipes or the second section of round pipes) are dragged to extend due to jamming between the round pipes; and
c. this section of round pipes must be fully extended before it can drag a next section of round pipes to extend.

When the spiral frame central platform 14 ascends, the central telescopic feeding pipe 6 retracts, the status when the third section of round pipes is inserted into the second section of round pipes 6-2 which ascends along with the spiral frame central platform 14 is as follows:
a. the third section of round pipes starts to insert into the lower second section of round pipes 6-2;
b. no premature insertion of other sections of round pipes occurs during the insertion process;
c. once this section of round pipes is fully inserted, it remains in the stationary status relative to the second section of round pipes 6-2, the first section of round pipes, and the spiral frame central platform 14. At this point, a next section of round pipes (the fourth section of round pipes) begins to insert.

Based on the extension and retraction characteristics of the central telescopic feeding pipe 6 in the Eurosilo, as a coal conveying channel, water vapor and coal dust generated during coal transportation inevitably adhere to an inner wall of the pipe. Even when several sections of round pipes overlap in the retracted status, a significant amount of fine coal particles still adheres to the inner walls of the round pipes through gaps among the round pipes. The amount of adhered coal increases over time. When the accumulated coal reaches a certain level, it fills space among the nested pipe walls, causing the entire or part of round pipes of the central telescopic feeding pipe 6 to bond into a single unit, rendering relative sliding impossible and thus disabling the extension and retraction actions. This issue is common during actual coal transportation operations. Additionally, the existing structural feature lacks a corresponding detection method. When such a situation occurs in the central telescopic feeding pipe 6 and cannot be detected, the ascending or descending movement of the spiral frame central platform 14 inevitably results in damage to the central telescopic feeding pipe 6, leading to various conditions such as disconnection or extrusion deformation. Due to the special environment inside the Eurosilo, a maintenance cost and time are relatively high, which significantly affect the normal operation of the Eurosilo. Moreover, with the characteristics of coal, such as increase in moisture, viscosity, and particle size, a frequency of such failures would increase. Therefore, it is necessary to effectively detect the jamming condition of the central telescopic feeding pipe 6, so as to clean it in time and avoid damage failures.

To address this issue, the present scheme proposes a detection apparatus for a central feeding pipe of a coal storage Eurosilo. This detection apparatus is configured to detect a telescopic sliding status of the central telescopic feeding pipe 6 in the Eurosilo. When the telescopic status is abnormal, it can timely transmit a signal to the device control system, which would stop the operation through the control system. After the problem is resolved and normal operation is restored, the apparatus can continue to run. This can avoid serious consequences caused by a failure to detect the abnormal telescopic status of the central telescopic feeding pipe 6 and ensure the normal coal storage operation of the Eurosilo device.

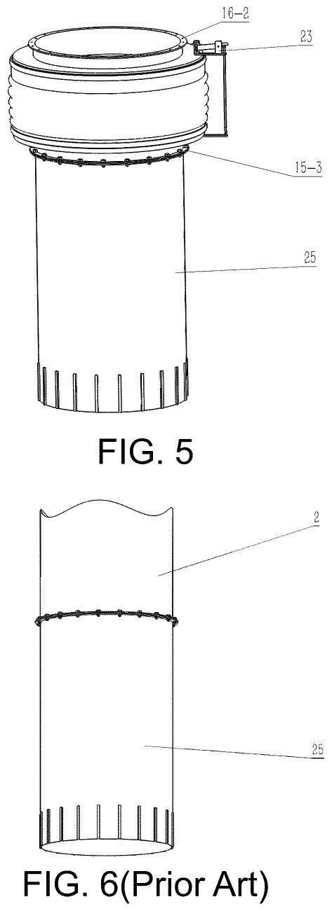

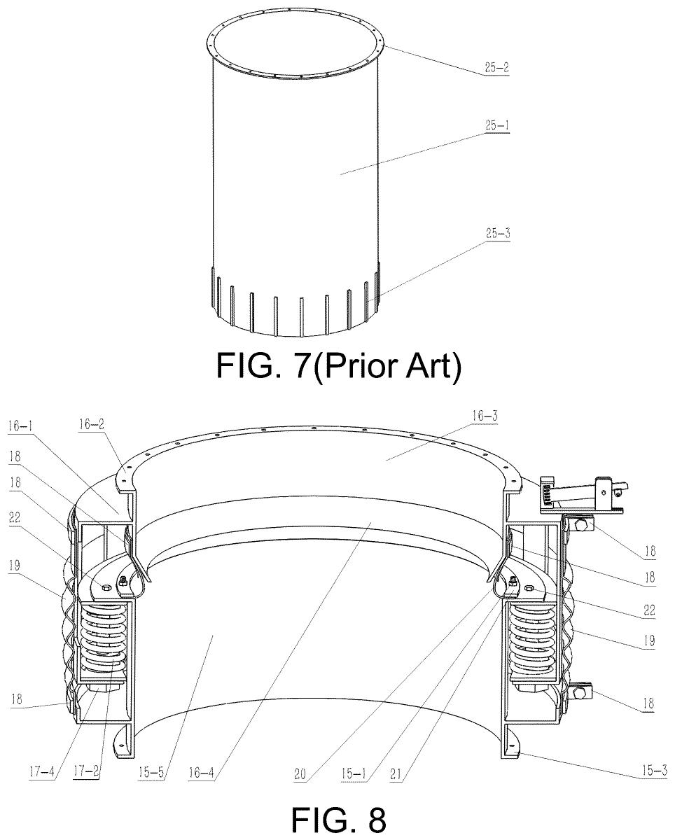

As shown in FIG. 5, the detection apparatus in this scheme is installed between the Eurosilo feeding inlet 2 and the connecting section 25. In the prior art, the connection between the Eurosilo feeding inlet 2 and the connecting section 25 is shown in FIG. 6, and the structure of the connecting section 25 is illustrated in FIG. 7. The upper end of the connecting section is provided with an upper connecting flange 25-2, and the lower end is provided with a lower limit stop block 25-3. In this scheme, the upper connecting flange 16-2 of the detection apparatus is bolted to the flange at the lower end of the Eurosilo feeding inlet 2, and the lower connecting flange 15-3 of the detection apparatus is connected to the flange at the upper end of the connecting section 25.

As shown in FIG. 8, the detection apparatus mainly consists of an upper connection fixing body 16, a lower connection sliding body 15, a spring body 17, an internal sealing belt 20, an external sealing sleeve 19, and a detector 23 among other components. The upper connection fixing body 16 consists of a connecting ring 16-1, an upper connecting flange 16-2, a straight section of the feeding pipe 16-3, an inclined section of the feeding pipe 16-4, a connecting ring base plate 16-5, a spring guide rod guiding hole 16-6, and a maintenance hole 16-7 among other components.

The lower connection sliding body 15 consists of sealing member fixing bolts 15-1, an upper bearing surface 15-2, a lower connecting flange 15-3, fixing screw holes 15-4, a feeding pipe 15-5, and a sealing member fixing ring 15-6 among other components.

The spring body 17 consists of an upper seat plate 17-1, a spring 17-2, a lower seat plate 17-3, a nut 17-4, a guiding screw rod 17-5, fixing screw holes 17-6, a lower seat plate 17-3, a spring guiding body 17-7, and guiding holes 17-8, among other components.

The internal sealing belt 20 and the external sealing sleeve 19 are made of flexible flame-retardant materials to provide a sealing function.

The detector 23 consists of a sensor mounting frame 23-1, a rotating shaft 23-2, an action arm 23-3, a connecting pin 23-4, an upper fixed frame 23-5, a sensing body 23-6, a connecting rod 23-7, a lower movable frame 23-8, and a sensor 24, among other components.

The upper connection fixing body 16 and the lower connection sliding body 15 are connected together through the spring body 17. The upper connecting flange 16-2 of the upper connection fixing body 16 is bolted to the lower flange of the Eurosilo feeding inlet 2, while the lower connecting flange 15-3 of the lower connection sliding body 15 is bolted to the upper connecting flange 25-2 of the connecting section 25. The connecting section 25 is inserted into an innermost section of round pipes of the central telescopic feeding pipe 6, i.e., the smallest-diameter section of round pipes, and is dragged to be connected to the upper end of the central telescopic feeding pipe 6 through the lower limit stop block 25-3.

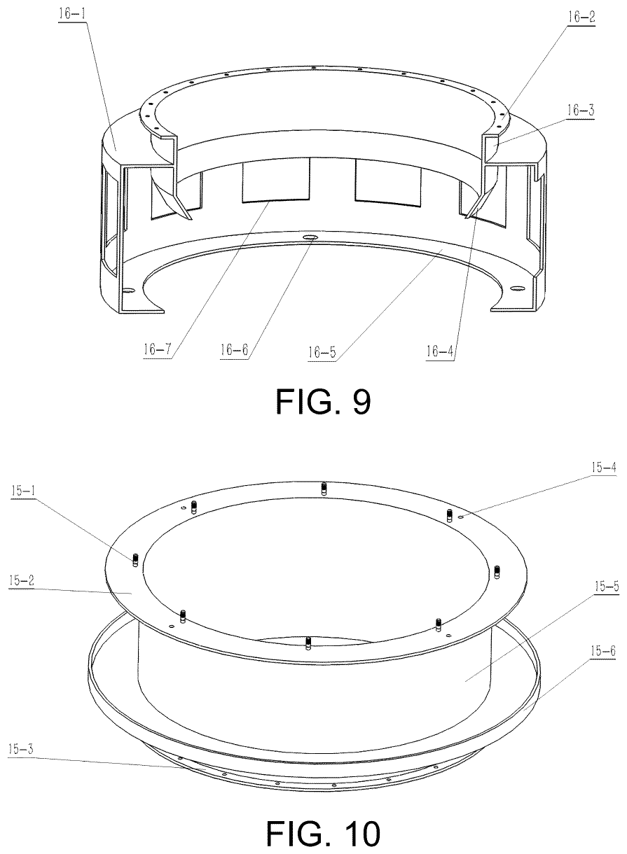

As shown in FIG. 9, a middle part of the upper connection fixing body 16 is a tubular straight section of the feeding pipe 16-3, serving as a passage for coal. An inclined section of the feeding pipe 16-4 has a conical feature, with a smaller diameter than the straight section of the feeding pipe 16-3, to prevent coal from impacting the internal sealing belt 20. The lower end of the upper connection fixing body 16 is provided with a connecting ring base plate 16-5 to support the spring body 17. Four spring guide rod guiding holes 16-6 are provided on it to fix the spring body 17. A certain number of inspection holes 16-7 are provided on an external cylindrical surface of the upper connection fixing body 16 to meet the needs of maintenance and inspection.

As shown in FIG. 10, a certain number of holes, namely fixed bolt holes 15-4, are provided on the upper bearing surface 15-2 of the lower connection sliding body 15. These holes are configured to securely fix the upper seat plate of the spring body 17 to the upper bearing surface 15-2 of the lower connection sliding body 15 using bolts. A certain number of screw rods are provided on the upper bearing surface 15-2 to cooperate with the sealing member pressure plate to fix the internal sealing belt 20. A sealing member fixing ring 15-6 is provided at the lower part of the lower connection sliding body 15 to press and fix a port of the external sealing sleeve via a hoop sleeve 18. A lower connecting flange 15-3 is provided at a bottom port of the lower connection sliding body 15 for connecting the connecting section 25. A central round pipe serves as the feeding pipe 15-5, which is the passage for coal entering the Eurosilo.

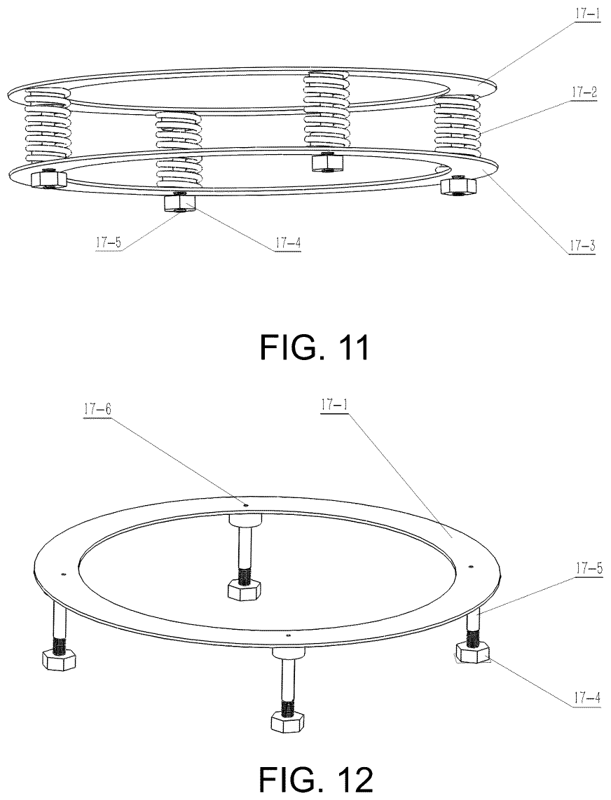

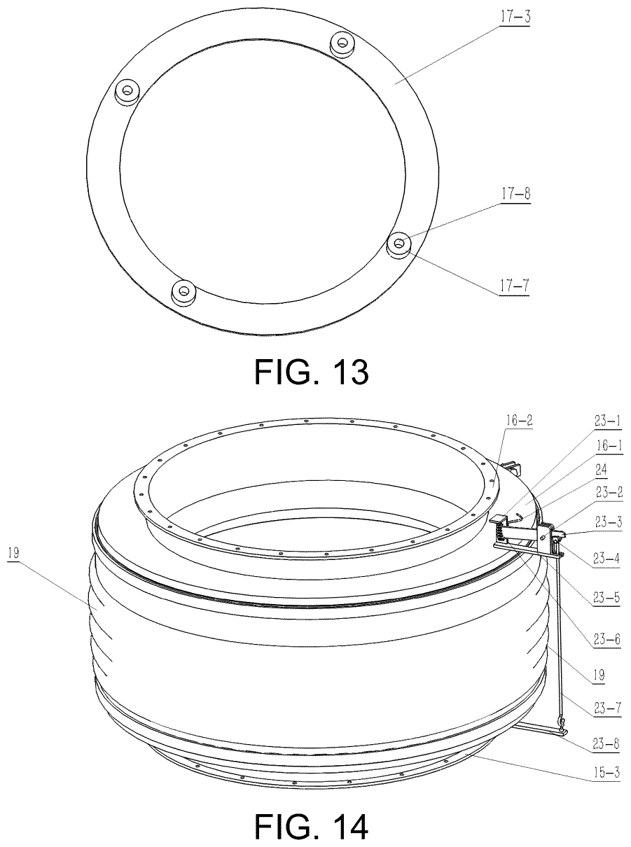

As shown in FIG. 11 to FIG. 13, the spring body 17 is an annular elastic component formed by fixing several springs 17-2 with the upper seat plate 17-1 and the lower seat plate 17-3. Several screw holes are provided on the upper surface of the upper seat plate 17-1, corresponding to the fixed screw holes on the upper bearing surface 15-2 of the lower connection sliding body 15, so as to fixedly connect the upper seat plate 17-1 of the spring body 17 to the upper bearing surface 15-2 of the lower connection sliding body 15. Guiding screw rods 17-5 are provided on the upper seat plate, and a large-diameter cylindrical platform is arranged between the guiding screw rods 17-5 and the upper seat plate 17-1 for spring positioning and guiding. The lower seat plate 17-3 is provided with spring guiding bodies 17-7, equal in number to the springs and having the same diameter as the large-diameter cylindrical platform on the upper seat plate 17-1, for spring positioning and guiding. Guiding holes 17-8 are provided in the middle of the spring guiding bodies 17-7 to allow the guiding screw rods 17-5 to pass through. After insertion, they are fixed with nuts 17-4. The annular spring body 17 formed in this way allows the distance between the upper seat plate 17-1 and the lower seat plate 17-3 to vary with an external force acting between the two plate surfaces.

When the upper connection fixing body 16, the lower connection sliding body 15, and the spring body 17 are assembled together, the upper connection fixing body 16 and the lower connection sliding body 15 can undergo a relative axial displacement along the central axis in response to changes in the external force. At a position near the feeding pipe for coal entering the Eurosilo, an internal sealing belt 20 is provided to connect a coal dropping pipeline between the upper connection fixing body 16 and the lower connection sliding body 15, preventing coal dust from escaping through joints, and considering that air inside the Eurosilo always contains a certain concentration of coal dust, a certain number of maintenance holes 16-7 are provided on an outer cylindrical surface of the upper connection fixing body 16. If such dust enters the moving mechanism through the maintenance holes 16-7, it would inevitably adhere to surfaces of various components, causing jamming. Therefore, an external sealing sleeve 19 is provided outside, with both ends of the sealing sleeve 19 fixed to the outer cylindrical surfaces of the upper connection fixing body 16 and the lower connection sliding body 15 by the hoop sleeve 18. These two sealing members enclose all components of the spring body 17 in a space unaffected by the internal environment of the Eurosilo, allowing the relative movement between the upper connection fixing body 16 and the lower connection sliding body 15 to occur entirely in a closed and stable environment, thus ensuring the operational reliability of the detection apparatus.

As shown in FIG. 14, the detector 23 is configured to detect the relative displacement between the upper connection fixing body 16 and the lower connection sliding body 15. The upper fixed frame 23-5 of the detector 23 is fixed on an upper surface of the connecting ring 16-1 of the upper connection fixing body 16. The lower movable frame 23-8 of the detection apparatus 23 is fixed on a lower plane of the sealing member fixing ring 15-6. The upper fixed frame 23-5 and the lower movable frame 23-8 are arranged in the same vertical plane. The rotating shaft 23-2 is provided on the upper fixed frame 23-5, with an action arm 23-3 installed on the rotating shaft. The action arm 23-3 has a lever feature, and several sensing holes are provided at one end of the action arm 23-3 as sensing bodies 23-6. The sensor mounting frame 23-1 is installed on the upper fixed frame 23-5 for mounting the sensor 24. A sensing point of the sensor 24 faces several sensing bodies 23-6. When the sensor 24 approaches these sensing bodies, it can trigger the generation of an electrical signal, which is transmitted to the Eurosilo control system, reflecting the telescopic status of the central telescopic feeding pipe 6. The action arm 23-3 rotates within a certain angular range around the rotating shaft 23-2. The distances from both ends of the action arm 23-3 to the rotating shaft are unequal. If the distance from the sensing bodies 23-6 to the rotating shaft 23-2 is designed to be multiple times a distance between the connecting pin 23-4 and the rotating shaft 23-2, then the movement distance of the sensing bodies 23-6 is multiple times an actual relative displacement between the upper connection fixing body 16 and the lower connection sliding body 15. This enables more precise detection feedback. The connecting pin of the action arm 23-3 is connected to the lower movable frame 23-8 via the connecting rod 23-7. In this way, the relative displacement between the upper connection fixing body 16 and the lower connection sliding body 15 can be converted into the rotational angle of the action arm 23-3, and the movement of the sensing bodies 23-6 can be detected by the sensor 24.

In practical applications, the sensor 24 may be of various types of non-contact proximity limiters. Hysteresis, response time, detection frequency, and repeatability of the proximity limiter can meet the requirements of the control system. The selected type of proximity limiter matches the material and surface color of the sensing bodies 23-6, ensuring that the electrical signal output by the sensor 24 meets the input requirements of the Eurosilo control system.

A primary purpose of the detector 23 is to convert the relative displacement between the upper connection fixing body 16 and the lower connection sliding body 15 into the movement of the sensing bodies 23-6, which can be detected by the sensor 24. Additionally, an electronic gyroscope can also be directly installed and fixed on the lower connection sliding body 15 to detect the motion status of the lower connection sliding body 15.

The present scheme proposes installing the detection apparatus between the Eurosilo feeding inlet 2 and the connecting section 25. The central telescopic feeding pipe 6 serves as the coal inlet passage of the Eurosilo. As coal falls through the central telescopic feeding pipe 6, dust is inevitably generated. This coal dust would adhere to the wall of the central telescopic feeding pipe 6. Additionally, the environment inside the Eurosilo outside the central telescopic feeding pipe 6 also contains a high concentration of dust, which accumulates at the joints of any two adjacent sections of the central telescopic feeding pipe 6. As the operation time of the Eurosilo increases, more and more coal accumulates and adheres to the inside and outside of the central telescopic feeding pipe 6, inevitably causing viscous resistance and jamming to the telescopic movement of the central telescopic feeding pipe 6. When encountering coal with high viscosity, several sections of round pipes may bond into a whole, losing the ability to slide relative to each other. In severe cases, the entire central telescopic feeding pipe 6 may bond into a whole, unable to perform the telescopic movement. When the spiral frame central platform 14 moves up and down, it would inevitably cause damage to the central telescopic feeding pipe 6.

When a coal accumulation height inside the Eurosilo is at its lowest, the spiral frame central platform is at its lowest position. The central telescopic feeding pipe 6 extends to its maximum length. Each section of round pipes extends the total feeding pipe by hooking and dragging each other. Since each section of round pipes has a fixed weight, after the central telescopic feeding pipe 6 extends, the weight of each section of extended round is transmitted to the upper section of round pipes through hooking points, and upward section by section until it finally reaches the Eurosilo feeding inlet 2. When the central telescopic feeding pipe 6 is at its maximum length, the weight of all extended round pipes is ultimately transmitted to the Eurosilo feeding inlet 2. When the coal in the Eurosilo accumulates to the maximum height, the length of the central telescopic feeding pipe 6 of the Eurosilo correspondingly retracts to the shortest. At this time, the minimum weight of the section of round pipes is transmitted to the Eurosilo feeding inlet 2, while the weight of the retracted and overlapped round pipes is borne by the spiral frame central platform 14 at the lower part. In other words, only the weight of the section of round pipes being dragged upward is transmitted upward to the Eurosilo feeding inlet 2. Based on the telescopic characteristics of the central telescopic feeding pipe 6, it can be seen that when the Eurosilo starts stacking materials from the bottom until it is full, the central telescopic feeding pipe 6 retracts from the longest length to the shortest. The weight of the central telescopic feeding pipe 6 acting on the Eurosilo feeding inlet 2 decreases with the shortening of the length, and vice versa.

In this scheme, the upper connection fixing body 16 and the lower connection sliding body 15 of the detection apparatus have the characteristic of changing the spacing under the external force through the spring body 17. The upper connection fixing body 16 is fixedly connected to the Eurosilo feeding inlet 2 through a flange interface, and the lower flange of the lower connection sliding body 15 is connected to the upper connecting flange 25-2 of the connecting section 25. Then, the connecting section 25 is inserted into the central telescopic feeding pipe 6, and the lower limit stop block 25-3 of the connecting section 25 drags the upper limit stop ring of the uppermost section of round pipes of the central telescopic feeding pipe 6 to connect with the upper port of the central telescopic feeding pipe 6. When the central telescopic feeding pipe 6 extends or retracts, the weight of the extended part of the round pipes is transmitted upward to the Eurosilo feeding inlet 2; after adding the detection apparatus, this weight acts on the spring body 17 via the lower connection sliding body 15, causing the spring body 17 to compress and the axial distance between the upper connection fixing body 16 and the lower connection sliding body 15 to be shorten; the extension length of the central telescopic feeding pipe 6 is directly proportional to the compression amount of the spring body 17, that is, proportional to the axial spacing between the upper connection fixing body 16 and the lower connection sliding body 15. At this time, the detector 23 arranged on the detection apparatus can real-time reflect the change of the axial spacing between the upper connection fixing body 16 and the lower connection sliding body 15, and amplify an action stroke through the lever characteristics of the action arm 23-3. The amplification times is determined according to the actual selected sensor type and precision grade.

When the spiral frame central platform 14 of the Eurosilo is at the lowest position at the bottom of the Eurosilo, the central telescopic feeding pipe 6 has a longest extended length. At this time, the weight of the extended round pipe acts on the detection apparatus, causing a maximum compression of the spring body 17 and a largest axial spacing between the upper connection fixing body 16 and the lower connection sliding body 15. When the spiral frame central platform 14 of the Eurosilo is at the highest position inside the Eurosilo, the central telescopic feeding pipe 6 has the shortest extended length. The weight of the extended round pipes acts on the detection apparatus, resulting in a minimum compression of the spring body 17 and a smallest axial spacing between the upper connection fixing body 16 and the lower connection sliding body 15. The variation in this spacing corresponds one-to-one with a serial number of the extended sections of round pipes. When the central telescopic feeding pipe 6 has several sections of round pipes bonded together due to adhering coal, these sections of round pipes are dragged out simultaneously during extension. The weight of the round pipes acting on the spring body 17 then exceed the weight of a single section of round pipe, causing a compression amount larger than normal which indicates an abnormal condition. During normal retraction of the central telescopic feeding pipe 6, the weight should decrease section by section. If several sections of the central telescopic feeding pipe 6 are bonded, their weights decrease simultaneously, which makes it possible to clearly identify that an abnormal condition has occurred. If the entire central telescopic feeding pipe 6 is bonded as a single whole, the weight of all extended round pipes of the central telescopic feeding pipe 6 decreases simultaneously during retraction. The detector 23 of the detection apparatus immediately registers this change, which is promptly fed back via the sensor 24. The control system can identify abnormalities by comparing a displacement signal from the detection apparatus with a normal signal, and determine the specific nature of the abnormalities based on the magnitude of deviation detected during the comparison. Additionally, since the axial spacing between the upper connection fixing body 16 and the lower connection sliding body 15 and the status is reflected by the deformation of the spring body 17. Even if the central telescopic feeding pipe 6 is bonded and its telescopic function fails, the up-and-down movement of the spiral frame central platform 14 only cause changes in the axial spacing between the connection fixing body 16 and the lower connection sliding body 15 of the detection apparatus. During this process, it would not cause a damage to the central telescopic feeding pipe 6, thus playing a role in protecting the central telescopic feeding pipe 6. The detection apparatus is also equipped with special sealing members inside and outside, which can keep the internal relative moving parts in a good environment at all times, ensuring normal, reliable, and long-term operation.

It can be seen that the detection apparatus can not only timely feedback whether the telescopic status of the central telescopic feeding pipe 6 is normal, but also play a protective role for the central telescopic feeding pipe 6. It itself is always in a sealed environment to ensure reliable operation.

In summary, the proposed scheme offers advantages of simple structure and inherent safety/reliability. It does not require modification to the original structure of the Eurosilo device, fully leveraging and matching the structural characteristics of the internal device in the Eurosilo. With small space occupation, it imposes little impact on daily inspection and maintenance. Additionally, the scheme is easy to implement. Once installed and adjusted, the apparatus requires small maintenance and can operate continuously and stably over a long term.

When the Eurosilo stores coal with smaller particle sizes, higher dust levels, and higher moisture content, the surface of the central telescopic feeding pipe is prone to accumulating a large amount of fine coal particles. This accumulation can cause jamming during the extension or retraction of the central telescopic feeding pipe. Furthermore, various other factors may also lead to jamming of the central telescopic feeding pipe. Once the jamming occurs, the abnormal operation of the central telescopic feeding pipe can result in its damage. The detection apparatus proposed in this scheme can monitor the telescopic actions of the central telescopic feeding pipe, promptly detect abnormalities, and prevent damage to the central telescopic feeding pipe caused by the jamming. This effectively improves the operational stability and reliability of the central telescopic feeding pipe.

The central telescopic feeding pipe is a critical coal conveying channel within the Eurosilo. Any jamming failure directly affects the normal operation of coal storage in the Eurosilo. Currently, there is no corresponding protective detection apparatus installed on central feeding pipes of existing Eurosilos. If a telescopic jamming failure occurs, it inevitably results in device damage. The detection apparatus proposed in this scheme can directly detect various jamming phenomena occurring in the central telescopic feeding pipe in the Eurosilo, preventing the resulting damages. It reduces the frequency and duration of downtime for maintenance and repair of the Eurosilo, lowers maintenance costs, and enhances the adaptability of the Eurosilo to store various types of coal.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A status detection apparatus for a central telescopic feeding pipe in a coal storage Eurosilo, is the status detection apparatus being installed between an Eurosilo feeding inlet and a connecting section and the status detection apparatus comprising an upper connection fixing body, a lower connection sliding body, a spring body, and a detector, wherein the upper connection fixing body is connected to a flange at a lower end of the Eurosilo feeding inlet, and the lower connection sliding body is connected to a flange at an upper end of the connecting section, the upper connection fixing body and the lower connection sliding body are connected via the spring body, the connecting section is inserted into a first section of round pipes of a central telescopic feeding pipe and is dragged to be connected to an upper limit stop ring of the first section of round pipes, and the detector is configured to detect a relative displacement between the upper connection fixing body and the lower connection sliding body to determine a current corresponding telescopic status of the central telescopic feeding pipe.

2. The status detection apparatus for a central telescopic feeding pipe in a coal storage Eurosilo according to claim 1, wherein an internal sealing belt is arranged between the upper connection fixing body and the lower connection sliding body, an external sealing sleeve is fixedly connected to outer sides of the upper connection fixing body and the lower connection sliding body via a hoop sleeve, and the internal sealing belt and the external sealing sleeve are configured to enclose the spring body in a space unaffected by an internal environment of the Eurosilo, ensuring that a relative movement between the upper connection fixing body and the lower connection sliding body is performed in a stable environment.

3. The status detection apparatus for a central telescopic feeding pipe in a coal storage Eurosilo according to claim 2, wherein the upper connection fixing body comprises a connecting ring, an upper connecting flange, a straight section of the feeding pipe, an inclined section of the feeding pipe, and a connecting ring base plate, wherein the upper connecting flange is connected to the flange at the lower end of the Eurosilo feeding inlet via a bolt; the connecting ring base plate is configured to support and connect the spring body; the inclined section of the feeding pipe is connected to a lower end of the straight section of the feeding pipe, jointly serving as a coal passage; and the inclined section of the feeding pipe is configured to prevent coal from impacting the internal sealing belt.

4. The status detection apparatus for a central telescopic feeding pipe in a coal storage Eurosilo according to claim 3, wherein an inspection hole is provided on a wall surface of the connecting ring, and a spring guide rod guiding hole is provided on the connecting ring base plate.

5. The status detection apparatus for a central telescopic feeding pipe in a coal storage Eurosilo according to claim 3, wherein the lower connection sliding body comprises an upper bearing surface and a lower connecting flange, wherein a feeding pipe is connected between the upper bearing surface and the lower connecting flange, the upper bearing surface is configured to be fixedly connected to the spring body, the lower connecting flange is connected to the connecting section, and the feeding pipe serves as the coal passage.

6. The status detection apparatus for a central telescopic feeding pipe in a coal storage Eurosilo according to claim 5, wherein a lower part of the lower connection sliding body is further provided with a sealing member fixing ring, which is configured to press and fix a port of the external sealing sleeve via the hoop sleeve.

7. The status detection apparatus for a central telescopic feeding pipe in a coal storage Eurosilo according to claim 5, wherein the spring body comprises an upper seat plate and a lower seat plate, with a plurality of springs connected between the upper seat plate and the lower seat plate; the upper seat plate is fixedly connected to the upper bearing surface of the lower connection sliding body; a guiding screw is arranged on the upper seat plate, and a large-diameter cylindrical platform is arranged between the guiding screw and the upper seat plate for spring positioning and guiding; and a spring guiding body for the spring positioning and guiding is provided on the lower seat plate.

8. The status detection apparatus for a central telescopic feeding pipe in a coal storage Eurosilo according to claim 1, wherein the detector comprises an upper fixed frame and a lower movable frame arranged in the same vertical plane; the upper fixed frame is fixed on an upper surface of the connecting ring of the upper connection fixing body; the lower movable frame is fixed on a lower plane of the sealing member fixing ring; a rotating shaft is provided on the upper fixed frame; an action arm is installed on the rotating shaft; the action arm has a lever feature, with several sensing holes as sensing bodies provided at one end of the action arm; a sensor is installed on the upper fixed frame, with sensing points of the sensor aligned with the sensing bodies; the sensor is connected to an Eurosilo control system; and when the sensor approaches the sensing bodies, the sensor triggers an electrical signal, which is transmitted to the Eurosilo control system to reflect a current telescopic status of the central telescopic feeding pipe.

9. The status detection apparatus for a central telescopic feeding pipe in a coal storage Eurosilo according to claim 8, wherein a connecting pin of the action arm is connected to the lower movable frame via a connecting rod, converting the relative displacement between the upper connection fixing body and the lower connection sliding body into a rotation angle of the action arm, and allowing the sensor to sense actions of the sensing bodies.

10. The status detection apparatus for a central telescopic feeding pipe in a coal storage Eurosilo according to claim 9, wherein the sensor is a non-contact proximity limit sensor.

11. The status detection apparatus for a central telescopic feeding pipe in a coal storage Eurosilo according to claim 8, wherein the sensor is a non-contact proximity limit sensor.
